(19) United States
(12) Patent Application Publication
(10) Pub. No.: US 2026/0117109 A1
(43) Pub. Date: Apr. 30, 2026

(54) THERMAL GREASE COMPOSITION

(71) Applicant: DOW SILICONES CORPORATION, Midland, MI (US)

(72) Inventors: Zhanjie Li, Midland, MI (US); Dan Zhao, Midland, MI (US); Devin M. Ferguson, Midland, MI (US); Eri Joffre, Shepherd, MI (US); Bizhong Zhu, Midland, MI (US); Cassandra Hale, Bay City, MI (US)

(21) Appl. No.: 19/161,920

(22) PCT Filed: Feb. 27, 2024
(86) PCT No.: PCT/US2024/017381

§ 371 Date: Sep. 3, 2025

Related U.S. Application Data
(60) Provisional application No. 63/451,720, filed on Mar. 13, 2023.

(51) Int. Cl. C09K 5/14; C08G 77/04; C08K 3/08; C08K 3/22; C08K 3/38; C08K 5/5419; C08K 5/5425; C08K 13/02

(52) U.S. Cl. CPC C09K 5/14; C08G 77/04; C08K 13/02; C08K 2003/0812; C08K 2003/2296; C08K 2003/385; C08K 5/5419; C08K 5/5425; C08K 2201/001

(57) ABSTRACT

The present invention relates to a composition comprising one or more filler particles and a first treating agent of Formula 1: and a second treating agent of Formula 2: where R, R¹, R², Y, x, and n are defined herein. The composition of the present invention is useful as a thermal grease that can achieve a combination of high thermal conductivities at thermal stability.

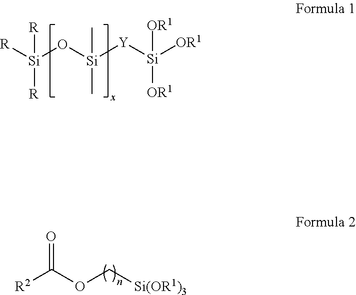

### BACKGROUND OF THE INVENTION

The present invention relates to a non-curable thermal grease composition comprising an ester-functionalized trialkoxysilane.

Non-curable thermal greases are widely used as thermal interface materials to transfer heat from a heat-generating electronic component to a heat sink. Useful thermal greases are characterized by high bulk thermal conductivity, low thermal resistance, low bondline thickness, good flowability and reworkability. More than 90 wt % of the components that constitute a thermal grease are a combination of thermally conductive fillers such as zinc oxide, alumina, aluminum, boron nitride, and aluminum nitride dispersed in a silicone-based fluid. The rapid increase of power and power density of electronic components results in greater heat generation, thereby requiring higher thermal conductivity for the thermal greases.

Thermal conductivity can be increased by increasing the loading of the thermal conductive fillers used in the preparation of the thermal grease. Unfortunately, however, higher filler loadings cause higher thermal grease viscosity, which diminishes key properties such as printability and thermal stability. To address this problem, US 2008/0213578 A1 (Endo) discloses a thermal grease composition that includes, inter alia, a trialkylsilyl-trialkoxysilyl-terminated polysiloxane (Component B, para [0034]) and an alkoxysilane (Component C, para [0035]); the inclusion of Component C provides a composition with lower viscosity, therefore, improved thermal grease thermal stability as compared to a grease that does not contain this component.

Still, there is a need to achieve even better thermal stability; accordingly, it would be an advantage in the art of non-curable thermal greases to discover a thermal grease that can achieve higher thermal conductivities without a concomitant decrease of thermal stability.

### SUMMARY OF THE INVENTION

The present invention addresses a need in the art of non-curable thermal greases by providing, a composition comprising, based on the weight of the composition, a) from 80 to 95 weight percent of one or more filler particles selected from the group consisting of aluminum, alumina, silicon, silicon dioxide, magnesium oxide, aluminum nitride, graphite, silicon carbide, and zinc oxide; b) 0.2 to 15 weight percent of a first treating agent of Formula 1:

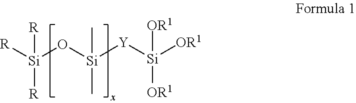

where R and R¹ are each independently C₁-C₆-alkyl; Y is O or CH₂—CH₂; x is from 20 to 200;
c) from 0.05 to 2 weight percent of ester-functionalized trialkoxysilane of Formula 2:

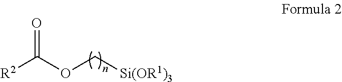

where R² is C₁-C₁₆-alkyl or C₂-C₁₆-alkenyl; each R¹ is independently C₁-C₆-alkyl; and n is 1 or 2; and
d) up to 8 weight percent boron nitride platelet particles.

The composition of the present invention is useful as a non-curable thermal grease.

### DETAILED DESCRIPTION OF THE INVENTION

The present invention is a composition comprising, based on the weight of the composition, a) from 80 to 95 weight percent of one or more filler particles selected from the group consisting of aluminum, alumina, silicon, silicon dioxide, magnesium oxide, aluminum nitride, silicon carbide, graphite, and zinc oxide; b) 0.2 to 15 weight percent of a first treating agent of Formula 1:

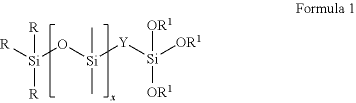

where R and R¹ are each independently C₁-C₆-alkyl; Y is O or CH₂—CH₂; x is from 20 to 200;
c) from 0.05 to 2 weight percent of ester-functionalized trialkoxysilane of Formula 2:

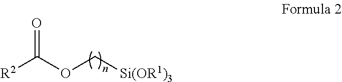

where R² is C₁-C₁₆-alkyl or C₂-C₁₆-alkenyl; each R′ is independently C₁-C₆-alkyl; and n is 1 or 2; and
d) up to 8 weight percent boron nitride platelet particles.

The composition preferably comprises aluminum and zinc oxide filler particles at a combined concentration in the range of from 85 or from 90 weight percent to 95 weight percent, based on the weight of the composition. The concentration of aluminum particles is preferably in the range of from 65 or from 68 or from 70 weight percent, to 80 or to 78 or to 75 weight percent of the composition. The aluminum particles are advantageously a bimodal distribution of a) smaller particles having a D₅₀ volume average particle size in the range of from 0.5 μm or from 1 μm, to 5 μm or to 3 μm and b) larger particles having a D₅₀ volume average particle size in the range of from 7 μm to 20 μm or to 15 μm or to 12 μm.

The concentration of the ZnO particles is preferably in the range of from 10 or from 15 weight percent, to 25 or to 20 weight percent, based on the weight of the composition. The ZnO particles preferably have a D₅₀ volume average particle size in the range of from 50 nm or from 80 nm, to 500 nm or to 200 nm or to 150 nm. D₅₀ and D₉₉ volume average particle sizes for aluminum, zinc oxide, and alumina particles refer to D₅₀ volume average particle diameter as measured using laser refractometry.

The concentration of the first treating agent of Formula 1, based on the weight of the composition, is in the range of from 0.2 or from 1 or from 3 or from 5 weight percent to 15 or to 10 weight percent. Y is preferably O, and R and R¹ are each preferably methyl; x is from 20 or from 50 to 200 or to 250.

The concentration of the ester-functionalized trialkoxysilane is in the range of from 0.05 or from 0.1 weight percent to 2 or to 1 or to 0.5 weight percent based on the weight of the composition. R is C₁-C₁₆-alkyl or C₁-C₁₀-alkyl or C₁-C₆-alkyl or C₂-C₁₆-alkenyl or C₂-C₁₀-alkenyl; R is preferably methyl; each R¹ is independently a C₁-C₆-alkyl group, preferably methyl; and n is preferably 1 or 2.

The ester-functionalized trialkoxysilane of Formula 2 can be prepared, for example, by the condensation of a salt of a carboxylic acid and a trialkoxysilyl alcohol, as described in WO 2011/101278 A1. The compound of Formula 1 can also be prepared by a base catalyzed reaction of a salt of a carboxylic acid and a chloroalkyltrialkoxysilane:

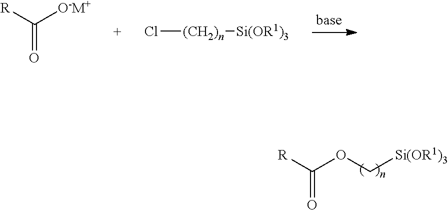

or by hydrosilylation of an allyl ester and a trichlorosilane, followed by alkanolysis:

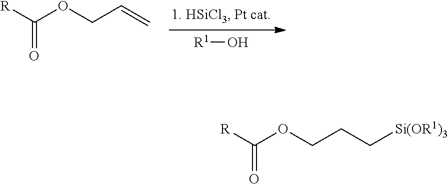

The composition optionally comprises boron nitride platelet particles, which increase thermal conductivity at the expense of viscosity. The platelet particles have a thickness, as measured by Scanning Electron Microscopy (SEM), preferably in the range of from 750 nm to 5 μm, and a D₅₀ particle size diameter, as measured by dynamic light scattering, preferably in the range of from 3 μm to 40 μm. The diameter-thickness aspect ratio of the boron nitride platelet particles is preferably in the range of from 2:1 or from 3:1 or from 4:1, to 50:1 or to 30:1 or to 20:1 or to 10:1. The boron nitride platelet particles have a hexagonal crystal structure. During assembly the boron nitride platelet particles align approximately along the same direction as the substrates after the platelet particles are applied between the substrates. As such, the D₅₀ particle size of the boron nitride platelet particles does not influence the final bondline thickness. Commercially available examples of boron nitride platelet particles include CarboTherm PCTP30 Boron Nitride from St. Gobain and PolarTherm PT110 from Momentive Performance Materials. The concentration of boron nitride platelet particles is in the range of from 0 or from 0.5 or from 1 or from 2 weight percent, to 8 or to 6 or to 5 or to 4 weight percent, based on the weight of the composition.

The composition of the present invention provides a non-curable grease that can achieve high thermal conductivities at dispensable and processable viscosities.

### EXAMPLES

In each of the following examples, pbw refers to parts by weight. All mixing was carried out using a Flacktek Speedmixer at 1500 rpm unless otherwise noted.

### General Procedure for the Preparation of a Thermal Conductive Material

A first filler treating agent of Formula 1 (TA1, 7.09 pbw, each R and R¹═CH₃; R═O; and x=110, prepared as described in US Pat. Pub. 2006/0100336), a second filler treating agent (TA-2 to TA-6, 0.2 pbw), Zoco 102 ZnO particles (ZnO, 17.38 pbw, 0.12 μm); were added to a MAX100 cup and mixed for 15 s. First aluminum particles (Al-1, 24.12 pbw, 2.0 μm, equivalent to TCP-2 Al powder) were then added to the mixer and the contents were mixed for 15 s. TCP-9 Al powder (Al-2, 48.24 pbw, 9.9 μm) was then added to the mixer and mixing was continued for 40 s. The mixture was then hand-mixed with a spatula then further mixed in the mixer for 40 s. Boron nitride (BN, 3 pbw) was then added to the mixer and mixing was continued for 15 s. The formulated composition was transferred to an aluminum pan and heated at 150° C. in vacuo (23 Torr) for 1 h.

Table 1 summarizes the materials and amounts used to prepare the examples and the comparative examples. TA-2, TA-3, TA-4, TA-5, and TA-6 have the following structures:

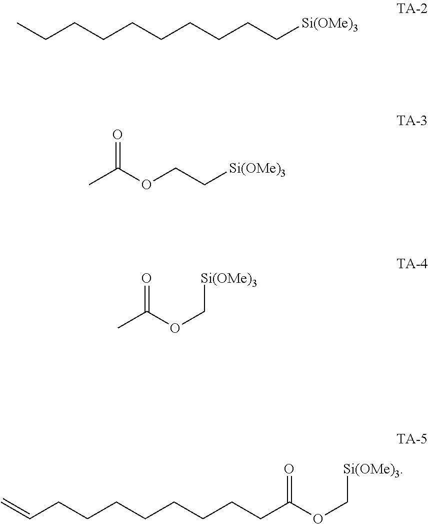

TABLE 1
Thermal Grease Compositions

| Material | Comp. 1 (g) | Comp. 2 (g) | Ex. 1 (g) | Ex. 2 (g) | Ex. 3 (g) |
|---|---|---|---|---|---|
| Al-1 | 24.12 | 24.12 | 24.12 | 24.12 | 24.12 |
| Al-2 | 48.24 | 48.24 | 48.24 | 48.24 | 48.24 |
| ZnO | 17.38 | 17.38 | 17.38 | 17.38 | 17.38 |
| BN | 3.00 | 3.00 | 3.00 | 3.00 | 3.00 |
| TA-1 | 7.26 | 7.09 | 7.09 | 7.09 | 7.09 |
| TA-2 | — | 0.17 | — | — | — |
| TA-3 | — | — | 0.17 | — | — |
| TA-4 | — | — | — | 0.17 | — |
| TA-5 | — | — | — | — | 0.17 |

### Viscosity Measurements

Complex viscosity at the dilatant point (Pa-s) was measured by ASTM D4440-15 (Standard Test Method for Plastics: Dynamic Mechanical Properties Melt Rheology) using instrument model ARES-G2 by TA Instruments equipped with 25-mm parallel plates (serrated steel). Testing conditions were based on strain sweep conducted at 25° C. with a gap of 2.0 mm. Care was taken to avoid air entrapment into the sample as it was being loaded. Excess material was trimmed from edge of the fixture with the flat edge of a spatula. The measurements were taken using the standard procedure of 10 rad/s oscillation frequency, sweeping from 0.01 to 300% strain amplitude with 20 sampling points per decade. The dilatant point was defined as the strain at which the complex viscosity starts increasing.

### Thermal Conductivity Measurement

Thermal conductivity was measured by ISO 22007-2:2015 (Test Method for Determining Thermal Conductivity) using a Hot Disk Instrument TPS 2500 S Hot Disk Instrument and a C₅₅₀₁ sensor. Each sample was placed into two cups with the planar sensor held between the cups. Analysis conditions: Fine-tuned analysis, Temperature drift compensation and time correction, calculation with selected between points 50-150.

Table 2 illustrates viscosity and thermal conductivity results for the samples. Viscosity refers to the viscosity at the dilatant point.

TABLE 2
Sample Viscosity and Thermal Conductivity Properties

| | | Viscosity | TC |
|---|---|---|---|
| | TA | (Pa · s) | (W/m · K) |
| CE-1 | — | 179 | 6.3 |
| CE-2 | TA-2 | 161 | 6.4 |
| IE-1 | TA-3 | 122 | 6.1 |
| IE-2 | TA-4 | 110 | 6.4 |
| IE-3 | TA-5 | 115 | 6.0 |

The results show a marked improvement in viscosity for the inventive examples comparative example 3.

### Sample Stability Measurements

### Thickness Measurement of Pre-Aged Sample

A sample (1 g) was dispensed on Q panel-AL-35, chromate pretreated substrate (0.65 mm×75 mm×125 mm). Aluminum spacers (1-mm thick) were placed on either side of the dispensed sample, and a glass slide (50 mm×75 mm) was placed over the spacers and sample. The spacers were removed, and a Texture Analyzer probe (13-mm diameter) was directed toward the glass slide at a rate 0.5 mm/s until the probe contacted the slide, at which time a 5-Kg force was applied against the slide for 30 s. The thickness of the sample (Thickₒ) was then measured to indicate its pre-aged flowability after subtracting the thickness of the substrate and the slide.

### Thickness Measurement of Aged Sample

The sample was dispensed, and the aluminum spacers (1-mm thick) and glass slide were positioned as described above. Stability of the sample was determined as follows: The assembly was heated to 125° C. for 21 d. The spacers were removed, and the probe was directed toward the glass slide at a rate 0.5 mm/s until the probe contacted the slide, at which time a 5-Kg force was applied against the slide for 30 s. The thickness of the sample (Thick_{f}) was then measured as described above to indicate its post-aged flowability.

Table 3 summarizes the initial pre-aged thickness of the samples and the thickness of the aged samples. Thickₒ refers to the initial thickness of the sample, and Thick_{f} refers to the thickness of the aged sample after having been subjected to the applied force.

TABLE 3
Stability Study of Aged Samples

| | Thickₒ (mm) | Thick_{f} (mm) |
|---|---|---|
| CE-1 | 0.29 | 1.00 |
| CE-2 | 0.27 | 0.87 |
| IE-1 | 0.25 | 0.49 |
| IE-2 | 0.24 | 0.47 |
| IE-3 | 0.24 | 0.47 |

The thicknesses of the comparative examples were not substantially reduced, indicating that the samples had hardened; in contrast, the examples that contained the ester treating agents of Formula 2 all exhibited flowability, which is an indicator of relative stability of the sample.

1. A composition comprising, based on the weight of the composition, a) from 80 to 95 weight percent of one or more filler particles selected from the group consisting of aluminum, alumina, silicon, silicon dioxide, magnesium oxide, aluminum nitride, silicon carbide, graphite, and zinc oxide; b) 0.2 to 15 weight percent of a first treating agent of Formula 1: 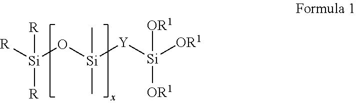
where R and R¹ are each independently C₁-C₆-alkyl; Y is O or CH₂—CH₂; x is from 20 to 200;
c) from 0.05 to 2 weight percent of ester-functionalized trialkoxysilane of Formula 2: 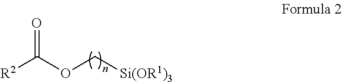
where R² is C₁-C₁₆-alkyl or C₂-C₁₆-alkenyl; each R¹ is independently C₁-C₆-alkyl; and n is 1 or 2; and
d) up to 8 weight percent boron nitride platelet particles.

2. The composition of claim 1 wherein the filler particles selected from the group consisting of aluminum, alumina, and zinc oxide.

3. The composition of claim 2 which comprises a) aluminum and zinc oxide filler particles at a combined concentration in the range of from 85 to 95 weight percent, based on the weight of the composition, and b) boron nitride platelet particles at a concentration in the range of from 0.5 to 8 weight percent, based on the weight of the composition.

4. The composition of claim 3 wherein Y is O; and each R and R¹ are methyl.

5. The composition of claim 2 wherein the concentration of the first treating agent of Formula 1 is in the range of from 3 to 10 weight percent, based on the weight of the composition; and the concentration of the ester-functionalized trialkoxysilane of Formula 2 is in the range of from 0.1 to 1 weight percent, based on the weight of the composition.

6. The composition of claim 3 wherein the concentration of aluminum particles is in the range of from 65 to 80 weight percent, based on the weight of the composition; and the concentration of the zinc oxide particles is in the range of from 10 to 25 weight percent, based on the weight of the composition; wherein the aluminum particles are a bimodal distribution of a) smaller particles having a D₅₀ volume average particle size in the range of from 0.5 μm to 5 μm; and b) larger particles having a D₅₀ volume average particle size in the range of from 7 μm to 20 μm; and wherein the zinc oxide particles have a D₅₀ volume average particle size in the range of from 50 nm to 200 nm.

7. The composition of claim 5 wherein the concentration of aluminum particles is in the range of from 70 to 78 weight percent, based on the weight of the composition; and the concentration of the zinc oxide particles is in the range of from 15 to 20 weight percent, based on the weight of the composition; wherein the aluminum particles are a bimodal distribution of a) smaller particles having a D₅₀ volume average particle size in the range of from 1 μm to 3 μm; and b) larger particles having a D₅₀ volume average particle size in the range of from 7 μm to 15 μm; and wherein the zinc oxide particles have a D₅₀ volume average particle size in the range of from 80 nm to 150 nm; wherein the concentration of the first treating agent of Formula 1 is in the range of from 5 to 10 weight percent; and wherein x is in the range of from 50 to 150.

8. The composition of claim 7 wherein second treating agent of Formula 2 is selected from the group consisting of: 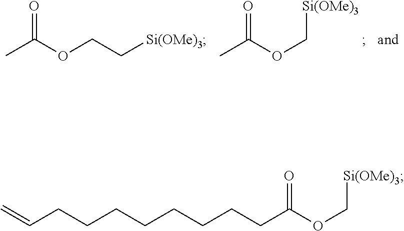
and the concentration of the second treating agent of Formula 2 is in the range of from 0.1 to 0.5 weight percent, based on the weight of the composition.

9. The composition of claim 7 wherein second treating agent of Formula 2 is: 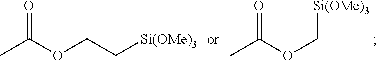
and the concentration of the second treating agent of Formula 2 is in the range of from 0.1 to 0.5 weight percent, based on the weight of the composition.
